(19) United States
(12) Patent Application Publication
(10) Pub. No.: US 2005/0012245 A1
(43) Pub. Date: Jan. 20, 2005

(54) Method for manufacturing magnetic recording medium substrates

(76) Inventors: Masatoshi Ishii, Takefu-shi (JP); Toshihiro Tsumori, Takefu-shi (JP); Ken Ohashi, Takefu-shi (JP)

Correspondence Address: MYERS BIGEL SIBLEY & SAJOVEC, PO BOX 37428, RALEIGH, NC, 27627, US

(21) Appl. No.: 10/889,272

(22) Filed: Jul. 12, 2004

(30) Foreign Application Priority Data
Jul. 15, 2003 (JP) 2003-197119

(51) Int. Cl. H01S 3/00; B23K 26/00; B26D 3/16

(52) U.S. Cl. 264/400; 264/159

(57) ABSTRACT

Provided is a method for improving the productivity of a coring step. More specifically, provided is a method for manufacturing a substrate for a magnetic recording medium substrate, comprising a step of coring for obtaining a plurality of doughnut-shaped substrates having a diameter of at most 55 mm from a monocrystalline silicon wafer of a diameter having at least 150 mm and at most 300 mm, wherein the coring is performed such that a leftover wafer excluding the plurality of substrates remains in one piece. In said step of coring, the coring is preferably performed using a laser cutting or a water jet cutting such that said minimum width of said surface of said leftover wafer is 1.5 to 2.5 times the thickness of the wafer.

### BACKGROUND OF THE INVENTION

1. Field of the Invention

The invention relates to a recording medium substrate for magnetic recording, and more specifically to a recording medium substrate for magnetic recording which is optimal as a small diameter substrate preferably having a diameter not more than 55 mm and more preferably having a diameter not more than 50 mm.

2. Description of the Related Art

The increase in recording density (surface density) of magnetic recording has been extremely rapid, the rapid increase over these past 10 years advancing continuously at yearly rates of 50 to 200%. At the mass production level, products with 70 Gbits/inch² are shipped, while surface recording densities more than twice higher, namely 160 Gbits/inch², have been reported at the laboratory level. Surface recording densities at the mass production level correspond to 80 Gbytes per one platter of a 3.5″ HDD (3.5 inch), and corresponds to 40 Gbytes per single platter of a 2.5″ HDD. At these recording volumes, installation of single platter recording media gives a sufficient volume for use in an ordinary desk top personal computer (equipped with a 3.5″ HDD) or a laptop personal computer (equipped with a 2.5″ HDD).

It is expected that recording densities will also continue to improve in the future. However, conventional horizontal magnetic recording methods are approaching their thermal fluctuation recording limit. Thus, when recording densities of 100 Gbit/inch² to 200 Gbit/inch² are reached, it is believed that it will be replaced by perpendicular magnetic recording. At the present time it is not certain what the recording limit of perpendicular magnetic recording will be, but it is believed that 1000 Gbit/inch² (1 Tbit/inch²) is achievable. If these types of high recording densities are achieved, it will be possible to obtain a recording volume of 600 to 700 Gbytes per single platter of a 2.5″ HDD.

As it is very likely that such a large volume will not be fully utilized by ordinary personal computer use, recording media having a diameter smaller than 2.51″ are gradually coming into use. Typically, there are substrates of 1.8″ or 1″, and 1.3″ HDDs was also sold in the past. HDDs of not more than 2″ have very small capacities at the present time, however if magnetic recording densities increase in the future, then a 1.8″ HDD in a personal computer (particularly in a laptop) can ensure a sufficient recording volume. Furthermore, the recording volume of a 1″ HDD is in the order of 1 to 4 Gbyte at the present, however if the volume was several times larger, many possibilities for a wide range of mobile uses would emerge, not limited just to digital cameras and the like, but also for personal computers and digital video cameras, information terminals, hand held music devices and mobile phones for example. Small diameter HDDs, small diameter recording media and substrates having diameter of not more than 2″ offer promising applications in the future.

As a substrate for the recording medium of a HDD, Al alloy substrates are mainly used for 3.5″ substrates, while glass substrates are mainly used for 2.5″ HDDs. There is a high possibility of HDDs in mobile applications, such as in laptop computers, receiving a shock. Because the possibility of data loss from scratches to the recording medium or the head resulting from head collision is large, the 2.5″ HDDs mounted in these devices have come to use very hard glass substrates. Consequently, there is also a large possibility that glass substrates will also be used in small diameter substrates of not more than 2″.

However, because small diameter substrates of not greater than 2″ are mainly used in mobile applications, shock resistance is of greater importance than for 2.5″ substrates mounted in laptop computers. Furthermore, from the need for the smaller size, there is a demand for making all parts including the substrate smaller and thinner. A thickness of the 2″ substrate board is demanded that is even thinner than the 0.635 mm standard thickness of the 2.5″ substrate. Due to the specifications required of such small diameter substrates, the demand is for substrates which are easily fabricated, which have a high Young's modulus and which have sufficient strength even though thin. Glass substrates have a number of problems on these points.

First, when the board thickness of the crystalline glass substrate which is actually used is not more than 0.635 mm, the Young's modulus is insufficient and resonance frequencies exist in the practical rotating region during rotation. Consequently, it is difficult to slim down further than this. Furthermore, although glass base plates are already used as substrates with a thickness in the 0.8 mm range, it is difficult to fabricate glass compositions which are any thinner than this, as demanded as HDD base plates. Because of this, it is necessary to adjust the thickness by lap-polishing from the 0.8 mm range down to the 0.5 mm range or even thinner. This is not preferable as it increases process costs and process time because the polishing time for width adjustment becomes very long.

Furthermore, the glass substrate is naturally a non-conductor, so there is the problem of charge up on the substrate when making films by sputtering. Thus, it is necessary to insert a metal film buffer between the substrate and the magnetic film in order to ensure favorable contact with the magnetic film. Basically, these technical problems have been solved, however this is one reason why it is difficult to use glass substrates in a sputter film forming process. Because of this, it would be ideal if it were possible to confer conductivity to the substrate, however this is difficult with glass substrates.

Just as glass substrates are mainly used even in 2.5° HDDs, Al alloy substrates are completely unsuitable for mobile applications. It was stated previously that the hardness of the substrate is insufficient. Because substrate stiffness is also insufficient, the only way to ensure that resonance frequencies are above the actual rotating region is to increase the thickness. Thus, it is not possible to consider it as a candidate substrate for mobile applications.

A number of other substitute substrates have been proposed, such as sapphire glass, SiC substrates, engineering plastic substrates, carbon substrates and the like, however from the standard evaluations of strength, processability, cost, surface smoothness and compatibility for film deposition and the like, all are inadequate as substitute substrates for small diameter substrates.

Use of a Si monocrystalline substrate has been proposed as a HDD recording film substrate (Japanese Patent Provisional Publication No. 6-176339/1994). A Si monocrystalline substrate is superior as the HDD substrate because of its excellent substrate smoothness, environmental stability and reliability, and because its stiffness is also comparatively high when compared to a glass substrates. Differing from a glass substrate, it has at least the conductivity of a semi-conductor. Furthermore, because it is generally the case that a regular wafer includes P-type or N-type dopant, the conductivity is even higher. Consequently, there is no problem with charge-up during sputter film formation as with glass substrates, and it is possible to sputter a metal film directly onto the Si substrate. Furthermore, because it has favorable thermal conductivity, the substrate is easily heated, film formation is possible even at high temperatures above 300° C. and it is excellently suited to the sputter film forming process. Si monocrystalline substrates for semi-conductor IC use are mass-produced as wafers having a diameter of 100 mm to 300 mm.

### SUMMARY OF THE INVENTION

However, it is presently difficult to obtain small diameter wafers having a diameter of at most 100 mm. Consequently, it is more realistic to cut out the desired small diameter substrate by coring from 6″ to 8″ wafers which are presently in common use. Because the price of silicon monocrystalline wafers is not low, it is important that as many HDD substrates are cut out from a single wafer as possible.

According to the invention, a method for increasing the productivity of a coring process is provided.

According to the invention, a method for manufacturing a substrate for a magnetic recording medium comprises a step of coring for obtaining a plurality of doughnut-shaped substrates having an outer diameter of at most 55 mm and a preferable internal diameter of at most 20 mm from a monocrystalline silicon wafer having a diameter of at least 150 mm and at most 300 mm, wherein the coring is performed such that a leftover wafer excluding the plurality of substrates remains in one piece.

It may be preferable that in the step of coring, the coring is performed such that a minimum width (or distance) of a surface of the leftover wafer after the plurality of substrates are cored is at least 1 and at most 5 times the thickness of the wafer. In the step of coring it may be also preferable to use a method in which the coring pressure on the monocrystalline silicon substrate is less easily exerted than during that of the cup grinding process. The step of coring may preferably use laser cutting or water jet cutting, and the core is extracted such that the minimum width of the surface of the leftover wafer after the plurality of substrates are cored is at least 1.5 times and not more than 2.5 times the thickness of the wafer.

According to the invention, the productivity of the coring step is improved by not breaking the cullet that is the leftover wafer, and leaving it in one piece.

### BRIEF DESCRIPTION OF THE DRAWINGS

FIG. 1 is a process overview showing an example of fabricating a substrate for a HDD magnetic recording medium, using a silicon monocrystalline wafer as a base plate.

FIG. 2 shows a method for core-extracting seven HDD substrates having a diameter of 65 mm from a monocrystalline silicon wafer 2 having a diameter of 200 mm.

FIG. 3 is a view of a minimum width (or distance) d1 in a step of coring.

### DETAILED DESCRIPTION OF THE PREFERRED EMBODIMENTS

The invention relates to manufacturing methods of substrates for HDD recording films wherein as many small diameter substrates as possible are efficiently cored from a silicon monocrystalline wafer by a coring process.

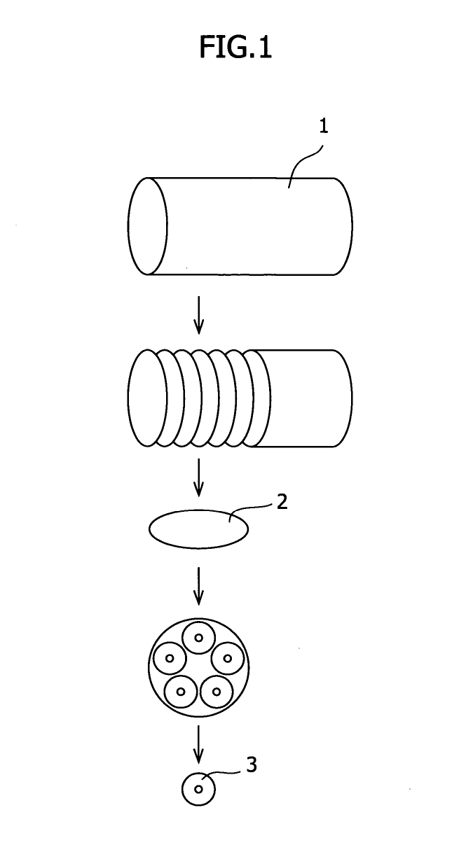

FIG. 1 is a process overview showing an example of fabricating a substrate for a HDD magnetic recording medium, using a silicon monocrystalline wafer as a base plate.

A monocrystalline silicon wafer 2 having a diameter of 200 mm is obtained by slicing a monocrystalline silicon rod. Subsequently, a plurality of doughnut-shaped substrates 3 having an outer diameter of not more than 55 mm are obtained in a step of coring. It may be preferably subjected to a step of chamfering of the inner and outer circumferential faces of the doughnut-shaped substrates 3 and a step of the inner and outer circumferential face-polishing. In a subsequent step of alkali etching, a step of polishing (or grinding) both surfaces and a step of washing, the small diameter substrates are usually manufactured.

A step of lapping for removing preferably 10 μm to 100 μm from the surface of the monocrystalline silicon wafer or the doughnut-shaped substrate may be comprised preferably before or after the step of coring, for example, before the step of coring, between the step of coring and the step of chamfering, between the step of chamfering and the step of circumferential face-polishing, or after the step of circumferential face-polishing. The step of lapping may be more preferably comprised, before the step of coring, between the step of chamfering and the step of circumferential face-polishing, or after the step of circumferential face-polishing.

The monocrystalline silicon wafer used in the step of coring may preferably have a plane orientation of (1 0 0), a diameter of at least 150 mm and not more than 300 mm and a thickness of 0.4 to 1 mm.

Semiconductor grade silicon monocrystalline wafers are expensive. Even if a 65 mm diameter substrate is fabricated using the monocrystalline base plate, it will cost from a few times to ten times the cost of a glass substrate. No matter how better the characteristic properties of the silicon monocrystalline substrate are, just this cost difference alone makes it difficult to put these to practical use.

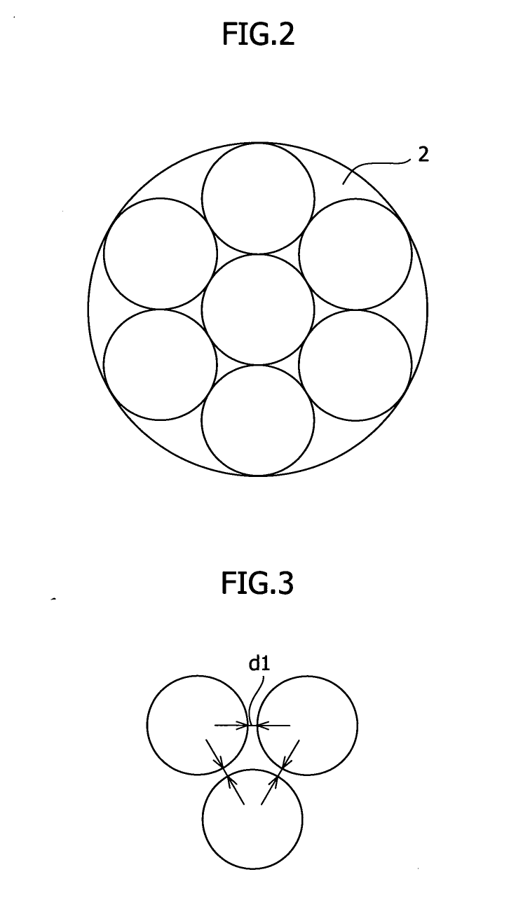

In the step of coring, coring of seven 2.5″ HDD substrates from an 8″ wafer can be performed as shown for example in FIG. 2. This method can be carried out according to the technique proposed in Japanese Patent Provisional Publication No. 10-334461/1998. In this case, by setting the process machining allowance during coring of the 2.5″ substrates so that the allowance is overlapped between adjacent cored substrates, coring of a maximum of seven 2.5″ substrates from the 8″ wafer can be performed. However, leftover portions remaining after coring of seven substrates (hereinafter referred to as “cullets”) are not linked, and scattered during processing. Although the maximum number of pieces cored from the wafer is desirably maintained as much as possible, however, if the cullets scatter during the process, the work becomes complex and difficult. In addition, the scatted cullets may collide with a disk to cause chipping or damage the disk surface.

First, air-suctioning a lower surface of the substrate is effective for wafer support. However, for substrates smaller than 2.5″, the cullet portions are small, and it is difficult to prevent scattering by using air-suctioning alone. Although a problem is solved if they are physically held down from behind or removed, this requires human intervention. Automation by robots is possible, however removal is not a simple task because the cullets which are not linked will move during processing.

Furthermore, if the number of cored small diameter substrates is reduced, the cullets are linked and can be handled as a single piece after coring. Consequently, if a minimum of three places on the wafer can be fixed, the cullets can be supported without scattering, and the manufacturing step of the coring can be simplified. However, this is not desirable because reducing the number of pieces which are cored raises the cost of the small diameter substrates. Accommodation of these conflicting demands for cullet treatment in the step of coring is a large problem.

In conventional coring by a cup grinder, it has always been necessary to maintain a minimum cullet width at a level of 5 mm (at least 6 times the wafer thickness) between adjacent cores in order to retain the cullet in one piece without fracture because pressure acts on the base plate wafer during coring. If the width is at a level smaller than this, cullets will break at a constant ratio. Even after coring, consideration was given to providing a cullet as a single piece, and setting the minimum width to as small as possible. It should be noted that the minimum width refers to the minimum width of the surface of the cullet, which is a minimum distance between the cores or between the core and the circumference of the base plate wafer. When the distance between the cores is shorter than the distance between a core and the circumference of the base plate, in FIG. 3 in which the distance d1 between the three cores is the same, d1 is the minimum width. If they are not the same width, the minimum width is the shortest of those widths.

By applying a laser cutting method or a water jet cutting method to the coring method, the inventors have found a way to complete core removal while maintaining the cullets in a single piece, even when the minimum cullet width is no more than 5 times the wafer.

Laser cutting is a method of cutting by concentrating laser light from an oscillating device such as a CO₂ gas laser, a YAG laser or a laser diode or the like.

It has been found that when thermal coring such as by laser cutting is used, the minimum width may be preferably at least 1.5 times and not more than 2.5 times the wafer thickness because pressure on the wafer substrate is not generated. However, instead of pressure, because of the increase in temperature of the laser irradiated portion, there may be cases in which a minimum width that is less than the wafer thickness cannot withstand the heatshock. Accordingly, the minimum width may be preferably at least the same as the wafer thickness. Furthermore, the minimum width may be preferably greater than five times the wafer thickness, because it increases the cost due to a reduction in the number of cored pieces. When a CO₂ laser is set as the laser light source in the laser cutting method, the power density may be comparatively low with respect to the large total power, heat may be easily transferred to the cored substrate and the cullets, and there may be a tendency to fracture because of heat shock. High power density solid-state lasers (for example YAG lasers) may be more preferable, as thermal loss to surrounding members is low and the laser power is actually utilized for coring itself.

Water jet cutting is a cutting method in which an abrasive material such as garnet having an average particle diameter of 20 to 200 am, is mixed into high pressure water of at least 100 MPa and jetted. Water jet cutting may be advantageous because the standoff distance (processing width) is small, a large pressure on the substrate is not generated, and heat effects are substantially absent. The width of the shortest cullet portion may be substantially the same width as with laser cutting, and may be preferably at least equal to but not more than 5 times the wafer thickness. It may be more preferably at least 1.5 times and not more than 2.5 times the wafer thickness.

Of course it is also possible to leave behind an integral cullet with a minimum width of not more than 5 times even with a conventional cup grinder by adjusting the manufacturing process accordingly. For example, with cupping, the minimum width portion of the cullet is strained just prior to coring, causing the greatest tendency to fracture. Although the productivity is sacrificed, halving of the grinder velocity and large reduction of the cutting pressure just prior to the coring (for example at a stage at which the remaining thickness to be cut is in the order of 0.1 mm to 0.2 mm.) can produce the cullet in one piece. However, because it is not pressure free like the laser cutting method, the minimum thickness-may not-be reduced to 2.5 times or less.

If the base plate wafer is fixed by at least three points due to the cullet being left in a single piece, there is no necessity to insert any surplus steps into the entire process. Furthermore, when the substrate for coring is a small diameter substrate having a diameter of 2″ or less the size of the leftover cullet portions is reduced further. Since methods such as air-suction are also more difficult to use, it is extremely advantageous to simplify the manufacturing process by cullet integrality.

The step of coring may include outer diameter coring (outer circumferential coring) and inner diameter coring (inner circumferential coring). Either the inner diameter coring or the outer diameter coring can be carried out at first.

Although it does not matter whether it is before or after the step of coring, it may be preferable to provide a step of lapping for polishing off preferably 10 μm to 100 μm from a wafer surface. When the step of lapping is provided after the step of coring, it may be provided, for example, between the step of coring and the step of chamfering, between the step of chamfering and the step of circumferential face-polishing, or after the step of circumferential face-polishing. The step of lapping may be preferably provided between the step of chamfering and the step of circumferential face-polishing, or after the step of circumferential face-polishing.

In the step of lapping, warping or swelling of the wafer base plate or the doughnut-shaped annular substrate may be inhibited and the thickness may controlled for the purpose of determining an appropriate amount to be polished in subsequent steps.

In the fabrication of the HDD substrate shown in FIG. 1, it may be also possible to provide a step of chamfering of the inner and the outer circumferential faces and a step of circumferential face-polishing after the step of coring of the base plate such as wafer.

The angle and dimensions of chamfering may be for the most part restricted as standard dimensions. Usually, the substrate can become a finished product through the step of chamfering. However, grinding particles and process waste which adheres to the edge or circumferential face may act to cause a reduction in substrate strength or may become a starting point for substrate rupture. Hence, it may be preferably subjected to the step of circumferential face-polishing after the step of chamfering, and then to the step of etching for removing the distorted layer. The circumferential face means the inner circumferential lateral surface and/or the outer circumferential lateral surface of the doughnut-shaped substrate.

After the step of circumferential face-polishing, or after the step of lapping after the step of circumferential face-polishing, it may be preferable that the substrate undergoes further steps including a step of alkali etching, a step of polishing the upper and lower surfaces of the substrate that has been alkali-etched, and a subsequent step of washing.

The step of alkali-etching for removing the process distortion from the step of lapping or the step of circumferential face-polishing, may be carried out, for example, by dipping in a 2 to 60 weight % solution of sodium hydroxide which is at 40 to 60° C.

The step of polishing the upper and lower surfaces of the alkali-etched substrate can be carried out in any of the methods known in the art. For example, it may be possible to clasp a substrate mounted in a carrier between an upper plate and a lower plate, and while rotating the substrate, to polish the substrate with colloidal silica as the grinding particles.

The step of washing can be carried out in any of the methods known in the art such as brush washing or chemical washing with an alkali and/or an acid solution.

The substrate for a magnetic recording medium of the invention can be treated in the same way as a conventional substrate. Introduction of a soft magnetic layer and a recording layer for example can produce a perpendicular magnetic recording medium. To increase close contact with the soft magnetic layer, it may be also possible to provide a primer layer in advance prior to forming the soft magnetic layer.

It may be also possible to provide a protective layer and a lubricating layer above the recording layer.

The invention will be explained based on examples below, however the invention is not limited to them.

An overview of examples is given below.

A large diameter monocrystalline silicon rod is sliced so that a wafer is formed. The wafer is lapped with abrasive particles to even out its thickness and surface. Next, the doughnut-shaped annular substrates are cut out of the wafer by a laser from a YAG laser oscillation apparatus or by cup grinding processing. A plurality of substrates are thus produced due to the above. Next, the edges of the inner and the outer circumferential faces of the substrate are removed by grindstone. Subsequently, the front and rear surfaces of the substrate are polished so that the desired substrate is obtained. Next, grinding agents adhering to the substrate are removed in the step of washing so that production of the substrate is completed.

### EXAMPLE 1

A wafer having a diameter of 200 mm was obtained by slicing a large diameter monocrystalline silicon ingot. Eleven doughnut-shaped annular substrates having an outer diameter of 48 mm and an inner diameter of 12 mm were obtained with a cup grinder. At this time, a minimum width dl between the doughnut-shaped annular substrates was set to 5 times the wafer thickness and the grind stone supply speed was reduced to be half at a point of 0.2 mm before complete coring. Consequently, the cullet which was the leftover wafer was left in one piece without damage. Subsequently, coring was carried out. It took 400 minutes to process five wafers and as a result 55 substrates were obtained. A large number of substrates were obtained in a short period of time without chipping or damage on the surface thereof caused by the cullet.

### EXAMPLE 2

Other than setting the minimum width d1 to be three times the wafer thickness, processing was carried out in the same manner as in Example 1. The cullet which was the leftover wafer was left in one piece without damage. Subsequently, coring was carried out. It took 440 minutes to process five wafers and as a result 60 substrates were obtained. A large number of substrates were obtained in a short period of time without chipping or damage on the surface thereof caused by the cullet.

### EXAMPLE 3

Apart from setting the minimum width d1 to be eight times the wafer thickness and leaving the grind stone supply speed at its regular speed, processing was carried out in the same manner as in Example 1. The cullet which was the leftover wafer was left in one piece without damage. However, the number of doughnut-shaped annular substrates obtained was as low as 8 pieces. Subsequently, coring was carried out. It took 370 minutes to process five wafers and as a result 40 substrates were obtained. The obtained substrates did not have chipping or damage on the surface thereof caused by the cullet.

### COMPARATIVE EXAMPLE 1

Apart from setting the minimum width d1 to 0.5 times the wafer thickness, processing was carried out in the same manner as in Example 1. The cullet which was the leftover wafer was damaged and scattered. Removing the damaged cullet, coring was continued. It took 560 minutes to process five wafers and as a result 60 substrates were obtained. However, substrates were also scratched during breakage of the cullet so that only 40 substrates could actually be used.

As given above, it has been found that the cullet remains in one piece and the substrates efficiently obtained when the minimum width is set at 2.5 times to 5 times the thickness of the wafer for cup grinding processing.

### EXAMPLE 4

A 200 mm diameter wafer was obtained from the large diameter monocrystalline silicon rod 1. Twelve doughnut-shaped annular substrates 3 having a diameter of 48 mm and an inner diameter of 12 mm were obtained with a YAG laser processing device. At this time, the minimum width d1 between the doughnut-shaped annular substrates was set to be twice the wafer thickness. The cullet which was the leftover wafer was left in one piece without damage. Subsequently coring was performed. It took 50 minutes to process five wafers and as a result 60 substrates were obtained. A large number of substrates were obtained in a short period of time without chipping or damage on the surface thereof caused by the cullet.

### EXAMPLE 5

A 200 mm diameter wafer was obtained from the large diameter monocrystalline silicon rod. Thirty doughnut-shaped annular substrates having an outer diameter of 26 mm and an inner diameter of 7 mm were obtained with a YAG laser processing device. At this time, the minimum width d1 between the doughnut-shaped annular substrates was set to three times the wafer thickness. The cullet which was the leftover wafer was left in one piece without damage. Subsequently coring was performed. It took 60 minutes to process five wafers 2 and as a result 150 substrates were obtained. A large number of substrates were obtained in a short period of time without chipping or damage on the surface thereof caused by the cullet.

### EXAMPLE 6

Apart from setting the minimum width d1 to be 1.2 times the wafer thickness, processing was carried out in the same manner as in Example 5. The cullet which was the leftover wafer left in one piece without damage. Subsequently coring was performed. It took 70 minutes to process five wafers and as a result 180 substrates were obtained. A large number of substrates were obtained in a short period of time without chipping or damage on the surface thereof caused by the cullet.

### COMPARATIVE EXAMPLE 2

Apart from carrying out coring by cup grinder, processing was carried out in the same manner as in Example 5. A 200 mm diameter wafer was obtained from a large diameter monocrystalline silicon rod. An attempt was made to obtain 30 doughnut-shaped annular substrates having a diameter of 26 mm and an inner diameter of 7 mm with a cup grinder, however the wafer was damaged and scattered, and none could be obtained.

### COMPARATIVE EXAMPLE 3

Apart from setting the minimum width d1 to be 0.5 times the wafer thickness, processing was carried out in the same manner as in Example 5. One portion of the cullet that was the leftover wafer was damaged. Removing the damaged cullet, coring was subsequently carried out. It took 100 minutes to process 5 wafers and as a result 200 substrates were obtained. However, the substrates were scratched when the cullets were damaged so that only 140 substrates could be actually used.

When the minimum width d1 is set to be 1 to 2.5 times the wafer thickness for the laser cutting as given above, it has been found that the cullet remains in one piece and the substrates can be even more efficiently obtained.

### EXAMPLE 7

A wafer having a diameter of 200 mm was obtained from a large diameter monocrystalline silicon rod. Eleven doughnut-shaped annular substrates having an outer diameter of 48 mm and an inner diameter of 12 mm were obtained with a water jet processing device using garnet particles #220. At this time, the minimum width d1 between the doughnut-shaped annular substrates was set to be three times the wafer thickness. The cullet which was the leftover wafer was left in one piece without damage. Subsequently, it took 40 minutes for coring to process five wafers and as a result 55 substrates were obtained. A large number of substrates were obtained in a short period of time without chipping or damage on the surface thereof caused by the cullet.

### EXAMPLE 8

Apart from setting the minimum width d1 to be 1.2 times the wafer thickness, processing was carried out in the same manner as in Example 7. The cullet which was the leftover wafer, left in one piece without damage. Subsequently, coring required 45 minutes to process five wafers and as a result 60 substrates were obtained. A large number of substrates were obtained in a short period of time without chipping or damage on the surface thereof caused by the cullet.

### COMPARATIVE EXAMPLE 4

Apart from setting the minimum width d1 to be 0.5 times the wafer thickness, processing was carried out in the same manner as in Example 7. A portion of the cullet which was the leftover wafer was damaged. Removing the broken cullet and continuing coring, 56 substrates were obtained from processing five wafers in 60 minutes. Substrates were also scratched when the cullets were damaged, so only 50 could actually be used.

It was found that when the minimum width d1 is set by water jet cutting to be 1 to 2.5 times the wafer thickness as given above, the cullet remains in one piece and the substrates can be even more efficiently obtained.

1. A method for manufacturing a substrate for a magnetic recording medium, the method comprising:
a step of coring for obtaining a plurality of doughnut-shaped substrates having an outer diameter of at most 55 mm from a monocrystalline silicon wafer having a diameter of at least 150 mm and at most 300 mm,
wherein the coring is performed such that a leftover wafer excluding the plurality of substrates cored remains in one piece.

2. The method for manufacturing a substrate for a magnetic recording medium according to claim 1,
wherein in said step of coring, the coring is performed such that a minimum width of a surface of said leftover wafer after the plurality of substrates are cored is 1 to 5 times the thickness of said wafer.

3. The method for manufacturing a substrate for a magnetic recording medium according to claim 2,
wherein in said step of coring, the coring is performed using a laser cutting or a water jet cutting such that said minimum width of said surface of said leftover wafer is 1.5 to 2.5 times the thickness of the wafer.
